(19) United States
(12) Patent Application Publication
(10) Pub. No.: US 2001/0011825 A1
(43) Pub. Date: Aug. 9, 2001

(54) Aeolian energy generator for cars

(76) Inventor: Dora Angelica Gericke de Vega, Buenos Aires (AR)

Correspondence Address: VENABLE, Post Office Box 34385, Washington, DC, 20043-9998, US

(21) Appl. No.: 09/735,612

(22) Filed: Dec. 14, 2000

(30) Foreign Application Priority Data
Dec. 14, 1999 (AR) 990106348

(51) Int. Cl. H02P 9/04; F03B 13/00; F03D 9/00

(52) U.S. Cl. 290/55; 290/54

(57) ABSTRACT

Aeolian energy generator for cars is of the kind constituted by rotative nucleus joined to radial blade or vanes, such as propellers, inserted among air currents with the object to make the nucleus of a transformer of mechanic power into electric power rotate. The generator comprises a wide pipe of low height, longitudinally positioned between the wheels of both sides of a car, and under its body, the pipe is completely open at two ends and a wide traversal opening in its superior face; and a rotative axis, which is coplanar to the superior face outstanding in one of the sides of it. All the rotative bodies are attached to its axis, outstanding half of them from the superior face with half the blades. The mentioned end of axis protrudes laterally from the pipe is mechanically attached to the power transformer.

The present invention relates mainly to an AEOLIAN ENERGY GENERATOR FOR CARS, which has been designed to use, first, the intensive air currents produced underneath such vehicles as they travel, increasing direct and proportionally to speed increments and resulting in a benefit useful for many applications, that is, to feed air conditioning equipment, to charge the battery of electricity storage batteries, to improve the performance of conventional dynamos or to replace them, etc.

More specifically, this patent of invention relates to a device of the kind detailed above, which falls into the kind of those constituted by one or more rotative and jointly involved bodies, of radial blades or vanes, exposed to air currents with the object of producing the rotation of the nucleus of a transformer of mechanic power into electric power, with the special detail that the air currents, specially used for that purpose, are those generated under the bodies of the cars, generally of an aerodynamic configuration, being the vehicles of back or front wheel drive.

It is well known the fact that it is absolutely necessary to have a minimum distance under the body of the car, in relation to the surface of the ground or the pavement, in order to comply with regulatory rules of the different countries, in order to avoid undesirable shocks with elements which may protrude from it. In the same way, as a consequence of the mentioned aerodynamic configuration, when the said vehicles push forward, they deviate the air from the atmosphere upwards, downwards and towards the sides. On the other hand, the bottom configuration of the mentioned car is usually unequal, including some elements which protrude longer than others, but always above the measure of the mentioned minimum distance, that is commonly correspondent to the differential gear, which is a mechanism located in a position lower than the axis, both the frontal and the back, irrespective of the fact of being vehicles of front or back wheel drive.

Apart from the considerations above mentioned, in the case of cars propelled by motors of internal combustion, either explosion or injection motors, electrical devices are used to start them, which consume electricity from the electricity storage batteries, being the mentioned electricity replaced during the operation of said motors, after a time which is proportional and direct to that spent during the starting of them. With this purpose, the motors are equipped with respective dynamos or alternator current generators joined by means of drives to the corresponding motors. The fact that said dynamos or alternators exceed in the mentioned charge of the storage battery is avoided with solenoid alternators.

Moreover, said generators of electricity (dynamos or alternators) refill the battery after the resulting consumption by sparks and heating necessary for the working of any motor, by switching the lights on, the sound of the horns, radio receptors, warming devices, lighters for cigarettes, etc.

The manufacture of cars with electrical propulsion is also known in the art, which instead of being feed by fuel, are feed by electric power which comes from special storage batteries which must be refilled or directly replaced after a certain amount of energy is delivered.

As a consequence, up to the moment, the consumption of electricity is practically universal, being the case of cars with internal combustion motors or electrical ones, enough reason by which the device of the present invention constitutes an efficient solution to increase the working life of the storage batteries employed while achieving high savings, which, taken to practice, will result in different improvements and variations of performance.

As a matter of fact this device comprises a new combination of means, which has a plurality of rotative bodies provided with radial blades or vanes, joined to a tangential axis, inserted transversally in a wide pipe, preferably flat-nosed, situated between the wheels of both sides of the car, and located longitudinally from the front towards the back, provided that the superior halves of the mentioned bodies and the halves of the vanes protrude above through a vertical window which, in the superior level contains the mentioned pipe, while said pipe has a end defining a wide opening for the entrance of air, completing the set with a dynamo or transformer of equivalent energy attached to the mentioned axis in such conditions than when the axis rotates due to the air currents produced by the speed under the car, the electric power is generated for those uses as detailed at the beginning of the present specification, because those currents push backwards the blades or vanes producing the rotation of all the rotative bodies in the same direction and simultaneously with the axis which holds them.

Obviously, this set must be preferably assembled with bolsters or bearings made of a material which lubricates by itself, such as Teflon or other similar plastic material, in order to counteract the effects of friction in the axis.

In relation to the blades or vanes of the rotative bodies, many variations are considered, as in the shapes of known turbines. It is important to point out that the curved vanes may conduct to better application of the air currents longitudinally located in relation to the pipes, because their shapes are similar to conical cavities which successively fill and empty in each round.

In order to make explicit the briefly explained advantages of the aeolian generator of the present invention, to which the users and those skilled in the art may add many more, as well as to make easier the understanding of its constructive, constitutive and working characteristics, it is hereinafter described a preferred non-limiting exemplary embodiment, illustrated by means of drawings and without a fixed scale in the attached picture.

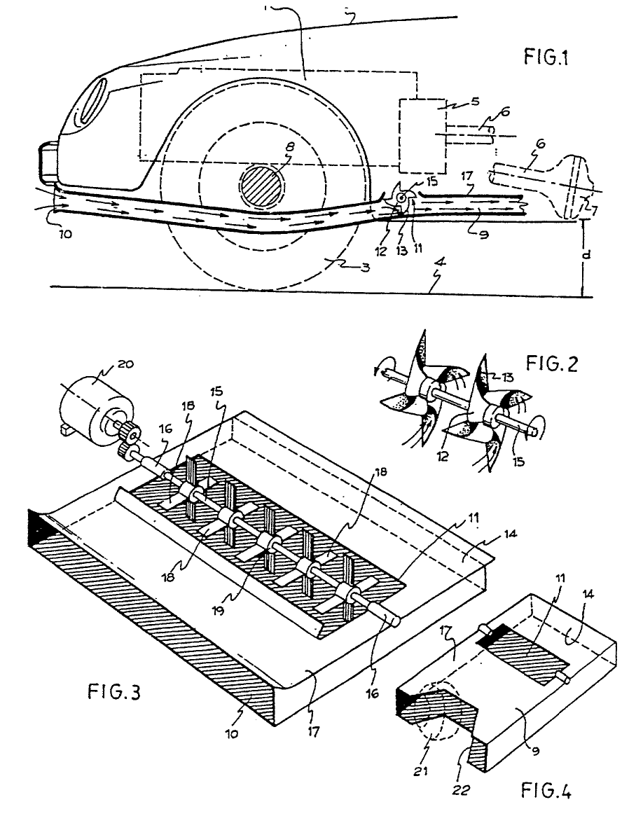

FIG. 1 is a side view of the outline, and a partial view of the front part of a back wheel drive car, furnished with an aeolian generator according to the present invention.

FIG. 2 is a partial perspective view of an alternative embodiment.

FIG. 3 is a full perspective view of another embodiment of the invention.

FIG. 4 is another different version, in a reduced scale, which takes into account the fact that the provided car for the present device would be a front wheel drive vehicle.

In all the drawings, same reference numbers correspond to the same or equivalent constitutive parts or elements of the prototype chosen as an example for the present explanation of this aeolian generator, object of the present invention.

As it is possible to see in FIG. 1, the car partially illustrated therein is one of the type having a frontal motor -1- covered by a conventional hood -2- assembled on wheels -3- supported on a ground or pavement -4- ; being the mentioned motor attached to the gearbox -5- , from which the descendant Cardan joint extends -6- up to the differential gear -7- , in this case for back wheel drive, which is not shown.

Under the frontal axis -8- and between the two frontal wheels, a wide longitudinal pipe -9- extends backwards, which is provided of three openings equally indispensable for this special case, that is, the entrance of air, or frontal -10- an intermediate superior window -11- through which half the height of the rotative bodies -12- appears with its blades or vanes -13- and, finally, a back opening -14- which can only be seen in FIG. 3 and 4, through which the air inside goes out without whirlwinds.

Among the elements described, with the exception of the wheel -3- , the one which has the least distance -d- in relation to the ground or pavement -4- is usually the differential gear -7- , back or front one.

The rotative bodies -12- provided with blades -13- will be constituted by small mills, where the mentioned blades are made of curved tin, with a shape similar to those mill made from millboard or similar. These mentioned blades reimburse the air which runs through the pipe at a different speed, depending on the quality of motion of the car, in such a way that push with power the axis -15- on which the mentioned small mills are assembled -13- as it is shown with details in FIG. 2. In order to use the air profitable, it is convenient that the small mills be near among them.

The assemble of the axis -15- will be preferably done by means of small cushions of Teflon -16- for friction damping, which will have their rotative axis substantially coplanar in relation to the superior face -17- of the mentioned flat nosed pipe -9-.

In the way described, all the circulating air due to the speed of the car, by the inner part of the mentioned pipe -9- will push the blades to practice an action which power will be multiplied by the amount of rotative bodies -12-, which would be an important amount at high speed.

In FIG. 3 there appears a representation as a non foreseen variant, among others which have not influence in the novelty of the present invention, in which the vanes are radial blades -18- joined to a cylindrical nucleus -19- assembled on the mentioned axis -15- coaxially. The mentioned blades and half of the nucleus are those outstanding upwards from the window -11- over the superior view -17- of the pipe In one or another of the axis ends -15- and outside the pipe -9- it is provided the location of a dynamo -20- or any other mechanism known by everyone, capable to transform the mechanic power produced by the rotation of the mentioned axis -15- into an electric one. , stating clear that the kind of element referred to -20- has no influence in the novelty of the present invention, due to it is a device known to be used for such purposes.

In FIG. 4 shows another different version, with a more reduced scale, which corresponds to those cases of front wheel cars, and, in this way, they have the differential gear in the front axis. That is why it is remarked as -21- the respective mechanism of transmission usually with side gear wheels and with -22- a corresponding neck in the front opening of the pipe -9- which influences the superior view -17- as well as the inferior one, which has no reference, giving space for the mentioned differential gear -21-.

Having described and determined the main nature and object of the present invention, as well as the way in which it can be put into practice, the following items are claimed as of exclusive property and rights:

1. AEOLIAN ENERGY GENERATOR FOR CARS, of the kind constituted by rotative nucleus joined to radial blades or vanes, such as propellers, inserted among air currents with the object to make the nucleus of a transformer of mechanic power into electric power rotate, characterized in that it comprises a wide pipe of low height, longitudinally positioned between the wheels of both sides of a car, and under its body, being the mentioned pipe completely open in its two ends, and including a wide transversal opening in its superior face, and a rotative axis, which is coplanar to the mentioned face outstanding in one of the sides of it, with all the rotative bodies attached to its axis, outstanding half of them from the mentioned superior face with half of the blades, and being the mentioned end of the axis which protrudes laterally from the pipe mechanically attached to the mentioned power transformer.

2. AEOLIAN GENERATOR, as set forth in claim 1, characterized in that assembling of both ends of the rotative axis in relation to the pipe, is performed by means of self-lubricating bushings made of Teflon.

3. AEOLIAN GENERATOR, as set forth in claim 1, characterized in that the transformer of mechanic power into electric power is an alternator.

4. AEOLIAN GENERATOR, as set forth in claim 1, characterized in that the transformer of mechanic power into electric power is a dynamo.
